(19) United States
(12) Patent Application Publication
(10) Pub. No.: US 2024/0012631 A1
(43) Pub. Date: Jan. 11, 2024

(54) REMEDIATION ENGINE FOR UPDATING DESIRED STATE OF INVENTORY DATA TO BE REPLICATED ACROSS MULTIPLE SOFTWARE-DEFINED DATA CENTERS

(71) Applicant: VMWARE, INC., Palo Alto, CA (US)

(72) Inventors: SYED ANWAR, Bangalore (IN); Kundan Sinha, Bangalore (IN); Shalini Krishna, Bangalore (IN); Kiran Ramakrishna, Bangalore (IN)

(21) Appl. No.: 17/898,584

(22) Filed: Aug. 30, 2022

(30) Foreign Application Priority Data
Jul. 7, 2022 (IN) 202241039169

(51) Int. Cl. G06F 8/65; G06F 9/445

(52) U.S. Cl. CPC G06F 8/65; G06F 9/44505

(57) ABSTRACT

Inventory data of software-defined data centers (SDDCs) are replicated across a group of management appliances of the SDDCs according to a desired state of the inventory data. The method of replication includes the steps of: comparing a timestamp of a first change item, which contains a change to a first item of the desired state, against a timestamp of the first item of the desired state; determining that the timestamp of the first change item has a time value that is after a time value of the timestamp of the first item; updating the first item of the desired state by applying the change to the first item included in the first change item; and issuing an instruction to one or more of the management appliances in the group to apply the desired state with the updated first item.

### RELATED APPLICATIONS

Benefit is claimed under 35 U.S.C. 119(a)-(d) to Foreign Application Serial No. 202241039169 filed in India entitled “REMEDIATION ENGINE FOR UPDATING DESIRED STATE OF INVENTORY DATA TO BE REPLICATED ACROSS MULTIPLE SOFTWARE-DEFINED DATA CENTERS”, on Jul. 7, 2022, by VMware, Inc., which is herein incorporated in its entirety by reference for all purposes.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

It has become common for multiple SDDCs to be deployed across multiple clusters of hosts. Each cluster is a group of hosts that are managed together by the management software to provide cluster-level functions, such as load balancing across the cluster through VM migration (e.g., VMware vSphere® vMotion®) between the hosts, distributed power management, dynamic VM placement according to affinity and anti-affinity rules, and high availability (HA) (e.g., VMware vSphere® High Availability). The management software also manages a shared storage device to provision storage resources for the cluster from the shared storage device, and a software-defined network through which the VMs communicate with each other. For some customers, their SDDCs are deployed across different geographical regions, and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not have to carry out management operations on the SDDC, such as configuration, upgrading, and patching, and the availability of the SDDCs is provided according to the service level agreement of the subscription.

In some cases, management appliances of multiple SDDCs may be linked together using a feature known as enhanced linked mode (ELM). The linking of the management appliances allows an administrator to log into any one of the management appliances to view and manage the inventories of all of the SDDCs of the ELM group. To enable this feature, a change in the inventory data in any one of the management appliances needs to be replicated to all of other management appliances in the ELM group. The replication may be performed using a multi-master database system or as described in U.S. patent application Ser. No. 17/591,613, filed Feb. 3, 2022, the entire contents of which are incorporated herein, according to a desired state of the inventory data. When the replication of the inventory data is performed according to the desired state of the inventory data, changes in the inventory data are reported by each of the management appliances in the ELM group, and the desired state is updated to reflect the reported changes. The replication of inventory data across all of the management appliances in the ELM group occurs when the updated desired state is applied to the management appliances in the ELM group.

### SUMMARY

One or more embodiment provide a method of replicating inventory data of SDDCs across a group of management appliances of the SDDCs according to a desired state of the inventory data. The method includes: comparing a timestamp of a first change item, which contains a change to a first item of the desired state, against a timestamp of the first item of the desired state; determining that the timestamp of the first change item has a time value that is after a time value of the timestamp of the first item; updating the first item of the desired state by applying the change to the first item included in the first change item; and issuing an instruction to one or more of the management appliances in the group to apply the desired state with the updated first item.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a conceptual block diagram of customer environments of different organizations that are managed through a multi-tenant cloud platform.

FIG. 2 depicts a cloud platform, and a plurality of SDDCs that are managed through the cloud platform, according to embodiments.

FIG. 3 illustrates a condensed version of a sample desired state document that includes an inventory data object.

FIG. 4 depicts the types of information that are stored in a database for the inventory data.

FIG. 5 depicts a sequence of commands that are issued and executed in response to an update to the database for the inventory data.

FIGS. 6A and 6B illustrate a condensed version of two sample change documents.

FIG. 7 is a flow diagram that illustrates the steps of a method for processing changes to the desired state reported by management appliances.

FIG. 8A is a flog diagram that illustrates the steps of a method for validating change items reported by the management appliances.

FIG. 8B illustrates changes to a desired state tracking table during execution of two of the steps depicted in FIG. 8A.

FIG. 8C illustrates changes to a desired state tracking table during execution of one of the steps depicted in FIG. 8A.

FIG. 9A is a flow diagram that illustrates the steps a method for applying the desired state to the management appliances that are in the same configuration group.

FIG. 9B illustrates a configuration group table that is used in one of the steps depicted in FIG. 9A.

FIG. 9C illustrates an interaction log that is used in two of the steps depicted in FIG. 9A.

FIG. 9D illustrates a desired state tracking table that is used in one of the steps depicted in FIG. 9A.

### DETAILED DESCRIPTION

One or more embodiments provide a cloud platform from which various services, referred to herein as “cloud services” are delivered to the SDDCs through agents of the cloud services that are running in an appliance (referred to herein as a “agent platform appliance”). The cloud platform is a computing platform that hosts containers or virtual machines corresponding to the cloud services that are delivered from the cloud platform. The agent platform appliance is deployed in the same customer environment, e.g., a private data center, as the management appliances of the SDDCs. In one embodiment, the cloud platform is provisioned in a public cloud and the agent platform appliance is provisioned as a virtual machine, and the two are connected over a public network, such as the Internet. In addition, the agent platform appliance and the management appliances are connected to each other over a private physical network, e.g., a local area network. Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the management software of the SDDCs is carried out through the respective agents of the cloud services.

The cloud platform according to one or more embodiments also manages replication of inventory data across management appliances of SDDCs, according to a desired state defined in a declarative document referred to herein as a desired state document. In the embodiments illustrated herein, the desired state document is created in the form of a human readable and editable file, e.g., a JSON (JavaScript Object Notation) file, and contains an inventory data object for inventory data. The desired state document is updated according to changes to the desired state that are reported by the management appliances. As each change item is reported, a remediation engine deployed on the cloud platform validates or rejects the change item. If validated, any change specified by the change item is applied to the desired state. If rejected, the desired state is not updated and the management appliance that reported the rejected change item is notified of the rejection and attempts to reconcile the rejected change item.

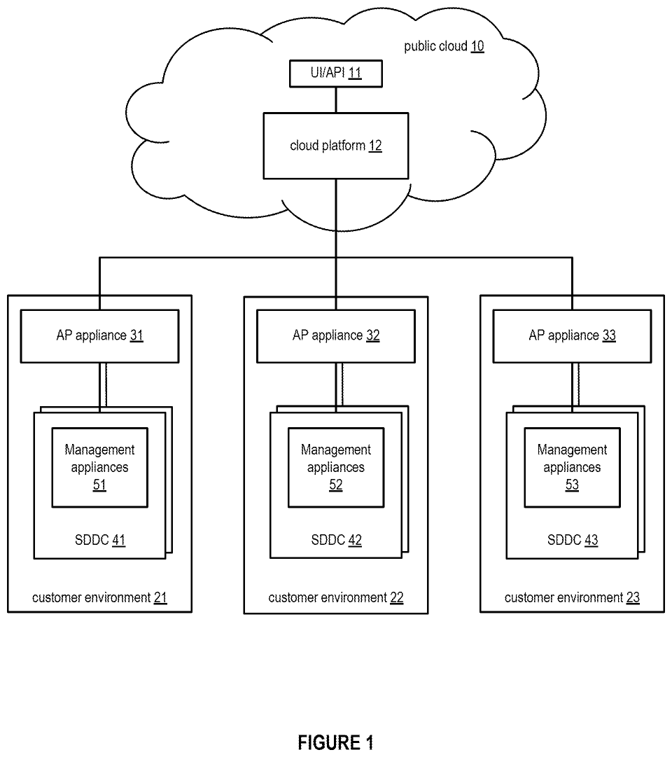

FIG. 1 is a conceptual block diagram of customer environments of different organizations (hereinafter also referred to as “customers” or “tenants”) that are managed through a multi-tenant cloud platform 12, which is implemented in a public cloud 10. A user interface (UI) or an application programming interface (API) of cloud platform 12 is depicted in FIG. 1 as UI/API 11. The computing environment illustrated in FIG. 1 is sometimes referred to as a hybrid cloud environment because it includes a public cloud 10 and a customer environment (e.g., customer environment 21, 22, or 23).

A plurality of SDDCs is depicted in FIG. 1 in each of customer environment 21, customer environment 22, and customer environment 23. In each customer environment, the SDDCs are managed by respective management appliances, which include a virtual infrastructure management (VIM) server appliance (e.g., the VMware vCenter Server® appliance) for overall management of the virtual infrastructure, and a network management server appliance (e.g., the VMware NSX® appliance) for management of the virtual networks. For example, SDDC 41 of the first customer is managed by management appliances 51, SDDC 42 of the second customer by management appliances 52, and SDDC 43 of the third customer by management appliances 53.

The management appliances in each customer environment communicate with an agent platform appliance, which hosts agents that communicate with cloud platform 12 to deliver cloud services to the corresponding customer environment. The communication is over a local area network of the customer environment where the agent platform appliance is deployed. For example, management appliances 51 in customer environment 21 communicate with agent platform appliance 31 over a local area network of customer environment 21. Similarly, management appliances 52 in customer environment 22 communicate with agent platform appliance 32 over a local area network of customer environment 22, and management appliances 53 in customer environment 23 communicate with agent platform appliance 33 over a local area network of customer environment 23.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions.

In the embodiments, each of the agent platform appliances and the management appliances is a VM instantiated on one or more physical host computers having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, any of the agent platform appliances and the management appliances may be implemented as a physical host computer having the conventional hardware platform described above.

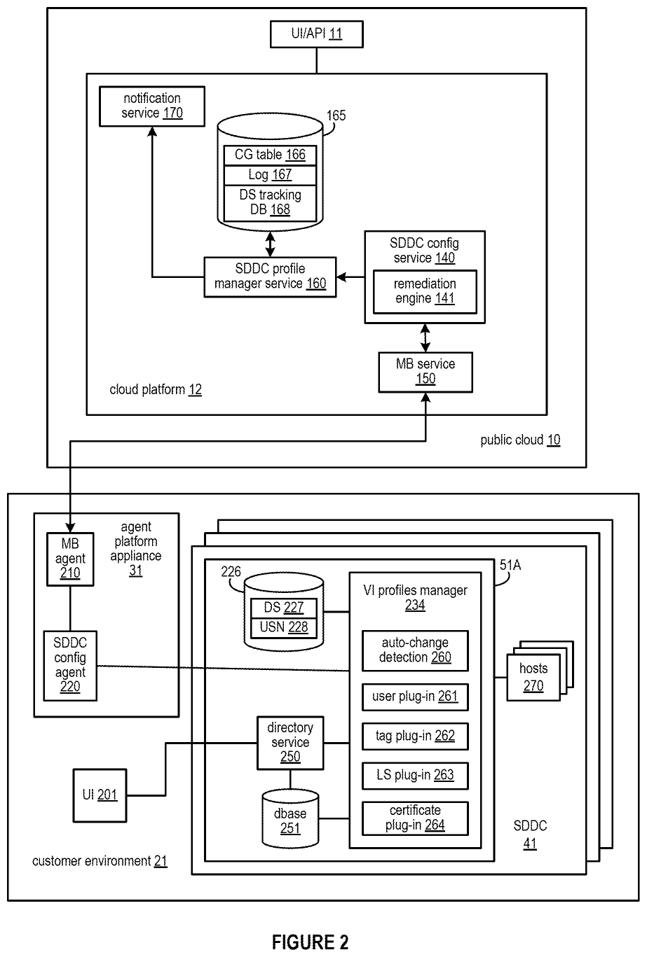

FIG. 2 illustrates components of cloud platform 12 and agent platform appliance 31 that are involved in managing the SDDCs according to a desired state. Cloud platform 12 is accessible by different customers through UI/API 11 and each of the different customers manage the configuration of its group of SDDCs through cloud platform 12 according to a desired state of the SDDCs that the customer defines in a desired state document. In FIG. 2, the management of the SDDCs in customer environment 21, in particular that of SDDC 41, is selected for illustration. It should be understood that the description given herein for customer environment 21 also apply to other customer environments, including customer environment 22 and customer environment 23.

Cloud platform 12 includes a group of services running in virtual infrastructure of public cloud 10 through which a customer can manage the desired state of its group of SDDCs by issuing commands through UI/API 11. SDDC configuration service 140 is responsible for accepting commands made through UI/API 11 and dispatching tasks to a particular customer environment through message broker (MB) service 150 to apply the desired state to the SDDCs. SDDC configuration service 140 includes a remediation engine 141 which is responsible for processing changes to the desired state reported by the SDDCs, updating the desired state, and dispatching tasks to the SDDCs to apply the updated desired state to the SDDCs. MB service 150 is responsible for exchanging messages with message broker (MB) agents deployed in different customer environments upon receiving a request to exchange messages from the MB agents. The communication between MB service 150 and the different MB agents is, for example, over a public network such as the Internet. SDDC profile manager service 160 is responsible for storing the desired state documents in data store 165 (e.g., a virtual disk or a depot accessible using a URL) and tracks the history of changes to the desired state document in a desired state tracking database 168 using a universal serial number (USN). The USN is a monotonically increasing number that is updated by remediation engine 141 as will be further described below. SDDC profile manager service 160 also maintains in data store 165 a configuration group table 166 and an interaction log 167. Configuration group table 166 identifies, for each configuration group, one or more management appliances (in particular, VIM server appliances) that belong to that configuration group. In the embodiments, inventory data is replicated across all of the management appliances in the same configuration group. Interaction log 167 identifies for each management appliance the USN associated with the latest desired state that has been applied to that management appliance.

Agent platform appliance 31 in customer environment 21 has various agents of cloud services running in cloud platform 12 deployed thereon. In the embodiments described herein, each of the cloud services is a microservice that is implemented as one or more container images executed on a virtual infrastructure of public cloud 10. Similarly, each of the agents and services deployed on the agent platform appliances is a microservice that is implemented as one or more container images executing in the agent platform appliances.

The agents depicted in FIG. 2 include MB agent 210 and SDDC configuration agent 220. MB agent 210 periodically polls MB service 150 to exchange messages with MB service 150, i.e., to receive messages from MB service 150 and to transmit to MB service 150 messages that it received from other agents deployed in agent platform appliance 31. If a message received from MB service 150 includes a task to apply the desired state, MB agent 210 routes the message to SDDC configuration agent 220.

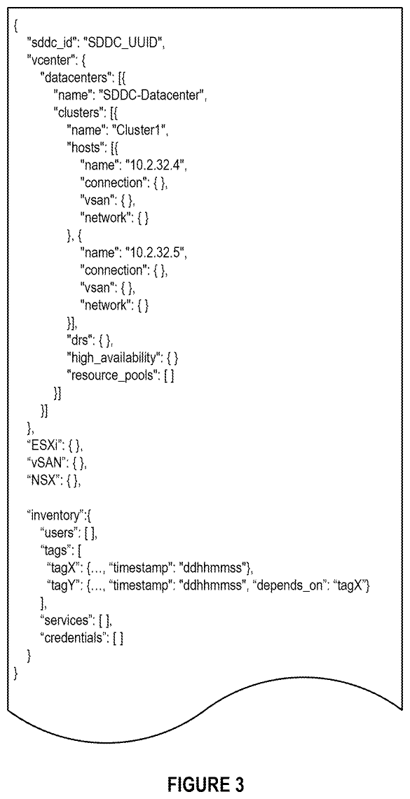

In the embodiments, the message that includes the task to apply the desired state, also includes a desired state diff document that contains all of the items of the desired state that needs to be applied to the SDDC, and a USN associated with the desired state document based on which the desired state diff document was generated. FIG. 3 illustrates a condensed version of a sample desired state document in JSON format, and includes entries for three management appliances of an SDDC identified as “SDDC_UUID.” The three management appliances are identified as “vcenter,” which corresponds to VIM server appliance 51A depicted in FIG. 2, “NSX,” which corresponds to a network management appliance (not shown in FIG. 2), and “vSAN,” which corresponds to another of the managements appliances (not shown in FIG. 2).

The desired state document also includes inventory data, which is managed by directory service 250 of VIM server appliance 51A. The inventory data includes user data, tag data, look-up service (LS) data, and certificate data. The sample desired state document depicted in FIG. 3 has an inventory data object for the inventory data, and the inventory data object includes a separate array for each of user data, tag data, LS data, and certificate data. The inventory data is stored in a database 251, which is, e.g., a key-value database.

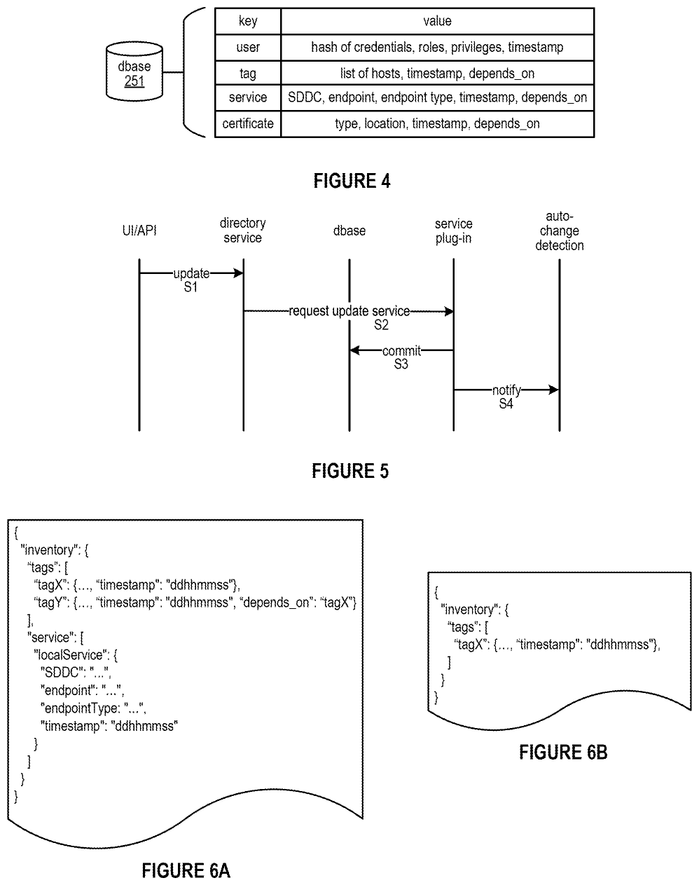

FIG. 4 depicts the different types of information that are stored in database 251 for each of user data, tag data, LS data, and certificate data. User data is stored in database 251 as a plurality of entries, one for each user, and each entry for a user contains the following information for the user: hash of credentials, roles, and privileges. Tag data is stored in database 251 as a plurality of entries, one for each tag, and each entry for a tag contains a list of hosts (in particular, host IDs) associated with the tag. LS data is stored in database 251 as a plurality of entries, one for each service, and each entry for a service contains the following information for the service: SDDC where the service is deployed, endpoint of the service, and the endpoint type. Certificate data is stored in database 251 as a plurality of entries, one for each certificate, and each entry for a certificate contains the following information for the certificate: type of certificate and location where the certificate is stored. The inventory data in database 251 is updated by service plug-ins installed in VI profiles manager 234. In particular, user data, tag data, LS data, and certificate data in database 251 are updated by user plug-in 261, tag plug-in 262, LS plug-in 263, and certificate plug-in 264, respectively.

The inventory data may be updated when VI profiles manager 234 receives an API call from SDDC configuration agent 220 to apply the desired state specified in the desired state diff document. In the embodiments, upon receiving the API call, VI profiles manager 234 applies the desired state by calling the respective plug-ins, updates the desired state document (depicted in FIG. 2 as DS 227) in data store 226 (which is, e.g., a virtual disk) by applying the changes to the desired state specified in the desired state diff document, and updates USN 228 that is saved in data store 226 with the USN which was sent with the message to apply the desired state.

The inventory data also may be updated when the inventory data is locally changed by the administrator of SDDC 41 through UI 201. In the embodiments, any local changes made to the inventory data are later to be replicated across all SDDCs, in particular to all VIM server appliances that are part of the same configuration group as VIM server appliance 51A, according to the desired state by sending a desired state change document that includes all local changes made to the desired state since the desired state was last applied to SDDC 41.

In general, any local changes made to the inventory data of any one of the VIM server appliances of a configuration group are replicated across all other VIM server appliances of the same configuration group by updating the desired state document to include the changes and applying the updated desired state document to all the other VIM server appliances of the same configuration group. As a result, user access to any VIM server appliance of a configuration group will be governed by the same user data regardless of which VIM server appliance of the configuration group that the user accesses. In addition, hosts that are located in different SDDCs can be managed as a single cluster as long as they are tagged with the same cluster ID, and a service in one SDDC can call a service in another SDDC by performing a look-up of LS data. Similarly, certificate data in one of the VIM server appliances of the configuration group are shared with other VIM server appliances of the configuration group so that a secure communication can be established with all VIM server appliances of the configuration group using the certificate data stored in database 251 and replicated across all VIM server appliances of the configuration group.

When local changes are made to the inventory data, the respective service plug-ins, user plug-in 261, tag plug-in 262, LS plug-in 263, and certificate plug-in 264, notify auto-change detection service 260 running in VI profiles manager 234 of the changes. Auto-change detection service 260 commits these changes to desired state document 227 stored in data store 226, increments the USN, and generates a change document that contains each of these changes along with metadata (“timestamp”:“ddddhhmmss”) to indicate the time of the change and metadata (“depends_on”:“ . . . ”) to indicate an item of the desired state that has a dependency to another item of the desired state. After generating the change document, auto-change detection service 260 notifies SDDC configuration agent 220, which in turn prepares a message that contains a change event, the change document, and the USN for MB agent 210 to transmit to MB service 150.

FIG. 5 depicts a sequence of commands that are issued and executed in response to an update to database 251 that is initiated through UI 201. At step S1, in response to user inputs made through UI 201, which contain desired changes to database 251, an update command is issued to directory service 250. Directory service 250 then calls the service plug-in(s) corresponding to the desired changes at step S2. For example, if tag data is being updated, directory service 250 calls tag plug-in 262. The corresponding service plug-in at step S3 commits the changes to database 251, and at step S4 notifies auto-change detection service 260 of the changes made to database 251.

FIGS. 6A and 6B each illustrate a condensed version of a sample change document in JSON format. The change document depicted in FIG. 6A includes change items of two types: (1) ones that contain changes to existing items of the desired state; and (2) ones that contain new items that need to be added to the desired state. The change document depicted in FIG. 6B includes change items that identify existing items of the desired state that need to be deleted from the desired state.

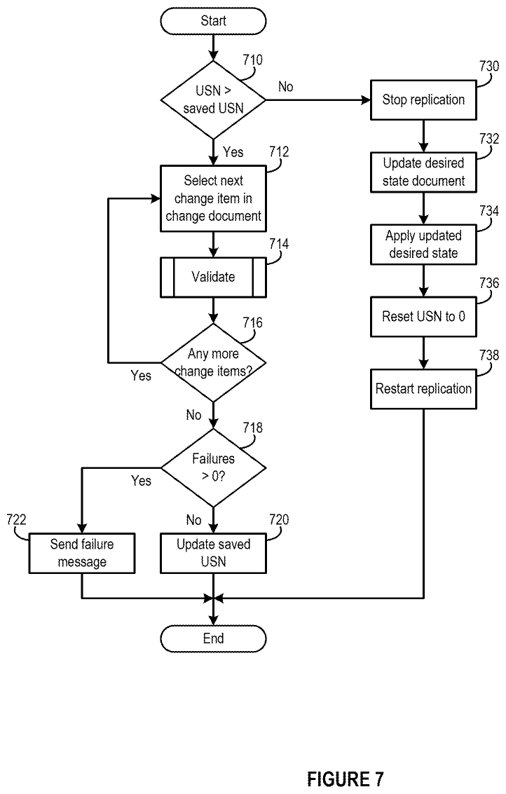

FIG. 7 is a flow diagram that illustrates the steps of a method for processing changes to the desired state reported by management appliances. This method is carried out by remediation engine 141 each time SDDC configuration service 140 is notified of a change event reported by a management appliance in a message from an SDDC configuration agent of any of the SDDCs. The method of FIG. 7 begins at step 710 at which remediation engine 141 compares the USN in the message to the USN that is saved in interaction log 167 for the reporting management appliance. If the USN in the message is not greater than the saved USN (Step 710; No), remediation engine 141 determines that the reporting management appliance has reverted to a snapshot thereof and the process continues to step 730. At step 730, remediation engine 141 sends a message to the reporting management appliance through MB service 150, MB agent 210, and SDDC configuration agent 220 to stop replication of its inventory data. Then, at step 732, remediation engine 141 updates the desired state document to remove all data items marked with the ID of the reporting management appliance. After updating the desired state document, remediation engine 141 at step 734 dispatches tasks to all the management appliances of the configuration group (of the reporting management appliance) to apply the changes specified in the desired state diff document prepared for the VIM server appliance to the current desired state of the VIM server appliance. At step 736, remediation engine 141 resets the USN of the reporting management appliance to zero and instructs SDDC profile manager service 160 to save the USN of the reporting management appliance that has been reset to zero in interaction log 167. Then, at step 738, remediation engine 141 sends a message to the reporting management appliance through MB service 150, MB agent 210, and SDDC configuration agent 220 to restart replication of its inventory data. The method ends after step 738.

Returning to step 710, if the USN in the message is greater than the saved USN (Step 710; Yes), remediation engine 141 carries out a validation process for each change item in the change document (steps 712, 714, and 716). If all change items have been processed successfully (step 718; No), the USN associated with the reporting management appliance (which may have been incremented during validation at step 714 as described below) is saved in interaction log 167 at step 720, and the process ends thereafter. However, if there is a failure in processing any one change item (step 716; Yes), remediation engine 141 at step 722 sends a failure message to the reporting management appliance through MB service 150, MB agent 210, and SDDC configuration agent 220, and the process ends thereafter. The failure message contains a failure record for each change item that failed validation at step 714, and includes an instruction to reconcile. Upon receiving the failure message and the instruction to reconcile, the management appliance has the option of either reconciling the failure (e.g., by updating its desired state to undo the change that failed validation or adding an item to the desired state to which the change item has a dependency) or maintaining the rejected change to the desired state, in which case the rejected change will be reported again as a change item.

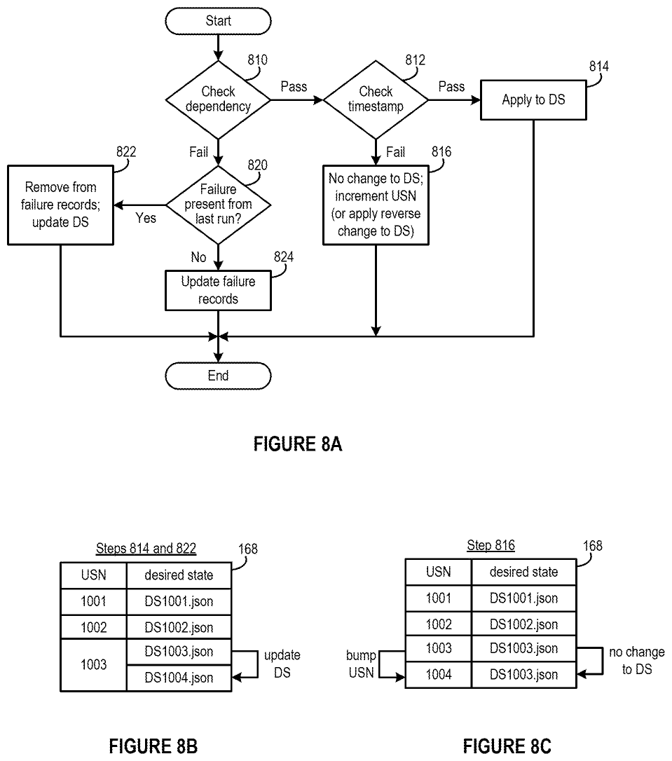

FIG. 8A is a flow diagram that illustrates the steps of a method for validating change items reported by the management appliances. This method is executed by remediation engine 141 for each change item selected at step 712 of FIG. 7. At step 810, remediation engine 141 checks to see if applying the change item will cause one or more dependencies in the desired state to be violated. For example, if item A of the desired state depends on item B of the desired state (as indicated by the “depends_on” metadata of item A), and the change specified by the change item results in a deletion of item B, the dependency check at step 810 fails. As another example, if item C is added to the desired state and item C has a dependency on item D of the desired state (as indicated by the “depends_on” metadata of item C), but item D does not exist in the desired state, the dependency check at step 810 fails. If the change item which failed the dependency check at step 810 is not a repeat failure (Step 820; No), remediation engine 141 adds the change item to the failure records at step 824, and the process ends thereafter. If, however, the change item which failed the dependency check at step 810 is a repeat failure (Step 820; Yes), this means that the reporting management appliance had a chance to reconcile this failure but did not. In such a case, step 822 is executed. At step 822, remediation engine 141 removes this change item from the failure records, and updates the desired state to add back in the item that was deleted from the desired state that caused the dependency check to fail. As depicted in FIG. 8B, remediation engine 141 updates the desired state at step 822, but it does not bump the USN. The process ends after step 822.

If the dependency check at step 810 passes (or the change item has no parent-child relationship with another item of the desired state), step 812 is executed. At step 812, remediation engine 141 checks the timestamp of the change item and compares it against the timestamp of the item of the desired state that it is changing. If the timestamp of the change item is earlier, the change item does not need to be applied to the desired state because the desired state already has the latest change applied thereto. However, this also means that the desired state of the reporting management appliance has to be updated with the latest desired state. This is carried out in one of two ways. The first way, depicted as step 816 in FIG. 8A, is to increment the USN associated with the current desired state without changing the desired state, as depicted in FIG. 8C. This will cause the latest desired state to be applied to the reporting management appliance at step 916 described below. The second way, depicted within parenthesis in step 816 of FIG. 8A, is to track the “reverse” change that need to be applied to the SDDC of the reporting management appliance and fetch the “reverse” change as one of the changes to be applied at step 916 described below.

Returning to step 812, if the timestamp of the change item is later, remediation engine 141 applies the change item to the desired state at step 814. As depicted in FIG. 8B, remediation engine 141 updates the desired state at step 814, but it does not bump the USN. The process ends after step 814.

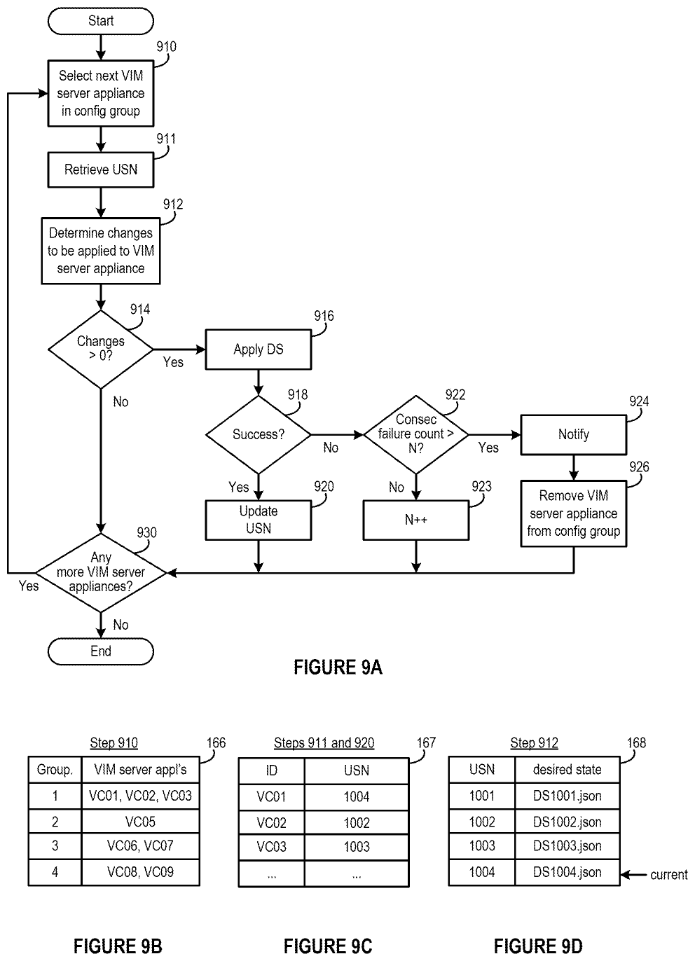

FIG. 9A is a flow diagram that illustrates the steps a method for applying the desired state to the management appliances, in particular VIM server appliances, that are in the same configuration group. For example, this method is carried out separately for each of groups 1, 2, 3, and 4 listed in configuration group table 166 shown in FIG. 9B. The method for any one configuration group begins at step 910, where remediation engine 141 selects one of the VIM server appliances in the configuration group. Then, at step 911, remediation engine 141 retrieves the USN associated with the selected VIM server appliance from interaction log 167, which is depicted in FIG. 9C. The USN retrieved at step 911 indicates the last desired state that was applied to the SDDC of the selected VIM server appliance. For example, interaction log 167 indicates that VIM server appliance with ID “VC01” has the desired state associated with USN “1004” applied to its SDDC, whereas VIM server appliance with ID “VC02” has the desired state associated with USN “1002” applied to its SDDC and VIM server appliance with ID “VC03” has the desired state associated with USN “1003” applied to its SDDC.

At step 912, remediation engine 141 determines the difference between the last desired state that was applied to the SDDC of the selected VIM server appliance and the current desired state. In the example given herein, it is assumed that the current desired state is associated with USN “1004” as depicted in FIG. 9D. Remediation engine 141 generates a desired state diff document for the selected VIM server appliance by performing a diff operation between the desired state document that was last applied to the selected VIM server appliance and the current desired state document of the configuration group. The desired state diff document contains no changes if the two documents are the same. For example, if the selected VIM server appliance is VIM server appliance “VC01,” the desired state diff document generated at step 912 contains no changes. On the other hand, the desired state diff document generated at step 912 for VIM server appliance “VC02” contains the differences between the DS1002.json file and the DS1004.json file. Similarly, the desired state diff document generated at step 912 for VIM server appliance “VC03” contains the differences between the DS1003.json file and the DS1004.json file.

If the desired state diff document contains no changes (step 914; No), steps 911, 912, and 914 are repeated for another VIM server appliance in the configuration group until there are no more VIM server appliances in the configuration group to select (step 930; No). If the desired state diff document does contain changes (step 914; Yes), remediation engine 141 applies the current desired state to the selected VIM server appliance by preparing a message containing the task to apply the desired state, the desired state diff document, and the USN of the current desired state, and sends the message to the selected VIM server appliance through MB service 150, MB agent 210, and SDDC configuration agent 220. If the selected VIM server appliance reports back that the desired state has been successfully applied (step 918; Yes), remediation engine 141 at step 920 updates the USN of the selected VIM server appliance in interaction log 167 to the USN of the current desired state.

If the selected VIM server appliance reports back a failure to apply the desired state or fails to report back within a certain timeout period, that the desired state has been successfully applied (step 918; No), the failure count (N) associated with this VIM server appliance is incremented by one at step 923 until the failure count becomes greater than N. When the failure count becomes greater than N (step 922; Yes), remediation engine 141 at step 924 notifies the administrator of this VIM server appliance that this VIM server appliance will be removed from the configuration group as a result of N failures and to remediate the desired state of the SDDC of the selected VIM server appliance. Then, at step 926, remediation engine 141 updates configuration group table 166 to remove this VIM server appliance from the configuration group.

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of replicating inventory data of software-defined data centers (SDDCs) across a group of management appliances of the SDDCs according to a desired state of the inventory data, said method comprising:
comparing a timestamp of a first change item, which contains a change to a first item of the desired state, against a timestamp of the first item of the desired state;
determining that the timestamp of the first change item has a time value that is after a time value of the timestamp of the first item;
updating the first item of the desired state by applying the change to the first item included in the first change item; and
issuing an instruction to one or more of the management appliances in the group to apply the desired state with the updated first item.

2. The method of claim 1, further comprising:
comparing a timestamp of a second change item, which contains a change to a second item of the desired state, against a timestamp of the second item of the desired state;
determining that the timestamp of the second change item has a time value that is before a time value of the timestamp of the second item; and
issuing an instruction to the management appliance that reported the second change item to apply the desired state that does not contain the change to the second item of the desired state.

3. The method of claim 2, further comprising:
determining that a third change item specifies a deletion of a third item from the desired state and that another item of the desired state has a dependency on the third item of the desired state;
maintaining the third item in the desired state; and
notifying the management appliance that reported the third change item that the third item has been maintained in the desired state because of the dependency.

4. The method of claim 2, further comprising:
determining that a third change item specifies an addition of a new item to the desired state and the new item has a dependency on a fourth item of the desired state that has been deleted;
updating the desired state to add back the fourth item to the desired state; and
issuing an instruction to one or more of the management appliances in the group to apply the updated desired state.

5. The method of claim 1, wherein the instruction to apply the desired state includes only a part of the desired state that changed since the most recent instruction to apply the desired state.

6. The method of claim 5, wherein the management appliances in the group include a first management appliance and a second management appliance, and the instruction to apply the desired state is issued to the first management appliance and not the second management appliance.

7. The method of claim 6, wherein the second management appliance is the management appliance in the group that reported the first change item.

8. The method of claim 1, wherein each of the management appliances in the group employs a database for storing the inventory data and any local change made to the inventory data stored in the database of one of the management appliances is reported as a change item to a cloud platform which performs the steps of comparing, determining, updating, and issuing.

9. A non-transitory computer readable medium comprising instructions to be executed in a computer system to carry out a method of replicating inventory data of software-defined data centers (SDDCs) across a group of management appliances of the SDDCs according to a desired state of the inventory data, said method comprising:
comparing a timestamp of a first change item, which contains a change to a first item of the desired state, against a timestamp of the first item of the desired state;
determining that the timestamp of the first change item has a time value that is after a time value of the timestamp of the first item;
updating the first item of the desired state by applying the change to the first item included in the first change item; and
issuing an instruction to one or more of the management appliances in the group to apply the desired state with the updated first item.

10. The non-transitory computer readable medium of claim 9, wherein the method further comprises:
comparing a timestamp of a second change item, which contains a change to a second item of the desired state, against a timestamp of the second item of the desired state;
determining that the timestamp of the second change item has a time value that is before a time value of the timestamp of the second item; and
issuing an instruction to the management appliance that reported the second change item to apply the desired state that does not contain the change to the second item of the desired state.

11. The non-transitory computer readable medium of claim 10, wherein the method further comprises:
determining that a third change item specifies a deletion of a third item from the desired state and that another item of the desired state has a dependency on the third item of the desired state;
maintaining the third item in the desired state; and
notifying the management appliance that reported the third change item that the third item has been maintained in the desired state because of the dependency.

12. The non-transitory computer readable medium of claim 10, wherein the method further comprises:
determining that a third change item specifies an addition of a new item to the desired state and the new item has a dependency on a fourth item of the desired state that has been deleted;
updating the desired state to add back the fourth item to the desired state; and
issuing an instruction to one or more of the management appliances in the group to apply the updated desired state.

13. The non-transitory computer readable medium of claim 9, wherein the instruction to apply the desired state includes only a part of the desired state that changed since the most recent instruction to apply the desired state.

14. The non-transitory computer readable medium of claim 13, wherein the management appliances in the group include a first management appliance and a second management appliance, and the instruction to apply the desired state is issued to the first management appliance and not the second management appliance.

15. The non-transitory computer readable medium of claim 14, wherein the second management appliance is the management appliance in the group that reported the first change item.

16. The non-transitory computer readable medium of claim 9, wherein each of the management appliances in the group employs a database for storing the inventory data and any local change made to the inventory data stored in the database of one of the management appliances is reported as a change item to a cloud platform that includes the computer system.

17. A cloud platform for managing the replication of inventory data of software-defined data centers (SDDCs) across a group of management appliances of the SDDCs according to a desired state of the inventory data, wherein the cloud platform is programmed to carry out the steps of:
comparing a timestamp of a first change item, which contains a change to a first item of the desired state, against a timestamp of the first item of the desired state;
determining that the timestamp of the first change item has a time value that is after a time value of the timestamp of the first item;
updating the first item of the desired state by applying the change to the first item included in the first change item; and
issuing an instruction to one or more of the management appliances in the group to apply the desired state with the updated first item.

18. The cloud platform of claim 17, wherein the steps further comprise:
comparing a timestamp of a second change item, which contains a change to a second item of the desired state, against a timestamp of the second item of the desired state;
determining that the timestamp of the second change item has a time value that is before a time value of the timestamp of the second item; and
issuing an instruction to the management appliance that reported the second change item to apply the desired state that does not contain the change to the second item of the desired state.

19. The cloud platform of claim 18, wherein the steps further comprise:
determining that a third change item specifies a deletion of a third item from the desired state and that another item of the desired state has a dependency on the third item of the desired state;
maintaining the third item in the desired state; and
notifying the management appliance that reported the third change item that the third item has been maintained in the desired state because of the dependency.

20. The cloud platform of claim 18, wherein the steps further comprise:
determining that a third change item specifies an addition of a new item to the desired state and the new item has a dependency on a fourth item of the desired state that has been deleted;
updating the desired state to add back the fourth item to the desired state; and
issuing an instruction to one or more of the management appliances in the group to apply the updated desired state.
